(19) United States
(12) Patent Application Publication
(10) Pub. No.: US 2015/0231630 A1
(43) Pub. Date: Aug. 20, 2015

(54) TUBE FOR PROCESSING OR STORING A SAMPLE

(71) Applicant: RareCyte, Inc., Seattle, WA (US)

(72) Inventors: Jennifer Chow, Seattle, WA (US); Daniel Campton, Seattle, WA (US); Joshua Nordberg, Bainbridge Island, WA (US); Steve Quarre, Woodinville, WA (US); David Stewart, Seattle, WA (US)

(73) Assignee: RareCyte, Inc., Seattle, WA (US)

(21) Appl. No.: 14/615,853

(22) Filed: Feb. 6, 2015

Related U.S. Application Data
(60) Provisional application No. 61/941,897, filed on Feb. 19, 2014.

(51) Int. Cl. B01L 3/00

(52) U.S. Cl. CPC B01L 3/5088; B01L 2200/0647; B01L 2200/16

(57) ABSTRACT

A tube for use in cell and cellular component analyses includes a main body with a flat end having a microwell to hold at least a portion of a sample and a second end. The microwell may be formed by a partition extending from the flat end to the second end or may be formed by a cavity within the flat end. The second end may be open or sealed, such as to prevent contamination. The cell and cellular component analyses may include, but are not limited to, lysis reactions, amplification reactions, nucleic acid analysis, cell culture, and cell viability assays.

### CROSS-REFERENCE TO A RELATED APPLICATION

This application claims the benefit of Provisional Application No. 61/941,897, filed Feb. 19, 2014.

### TECHNICAL FIELD

This disclosure relates generally to tubes for processing or storing a sample, though more specifically, for tubes for use in cell and cellular component analyses.

### BACKGROUND

Processing tubes for use in cell and cellular component analyses traditionally have curved bottoms and an internal surface with a sloped wall. The curved bottom makes it more difficult to obtain a quality image of a sample within the processing tube, whether it is before or after the cell and cellular component analysis. The sloped internal walls also inhibit sample movement to the bottom end of the processing tube due to the adhesive properties or electrostatic charges of the slope wall relative to the sample.

As a result, practitioners, researchers, and those working with cell and cellular component analyses continue to seek a device for obtaining quality images and enhancing the cellular and cellular component analyses.

### DESCRIPTION OF THE DRAWINGS

FIGS. 1A-1C show an example tube.

FIG. 1D shows an example tube.

FIG. 1E shows an example tube.

FIGS. 2A-2B show an example tube.

### DETAILED DESCRIPTION

A tube for use in cell and cellular component analyses includes a main body with a flat end having a microwell to hold at least a portion of a sample and a second end. The microwell may be formed by a partition extending from the flat end to the second end or may be formed by a cavity within the flat end. The second end may be open or sealed, such as to prevent contamination. The cell and cellular component analyses may include, but are not limited to, lysis reactions, amplification reactions, nucleic acid analysis (e.g. fluorescent in situ hybridization, branched DNA, and RNA analysis), cell culture (e.g. 5-bromo-2′-deoxyuridine (BrdU) uptake assay), and cell viability assays.

In the following description, the term “sample” is used to describe any object or amount of fluid added to the tube prior to the analysis, such that a sample to be analyzed makes up a portion of or the entirety of the fluid. For example, the sample may be a solution or suspension including the sample (e.g. phosphate buffered saline with a cell); or, the sample may be a cell.

### General Description of a Tube

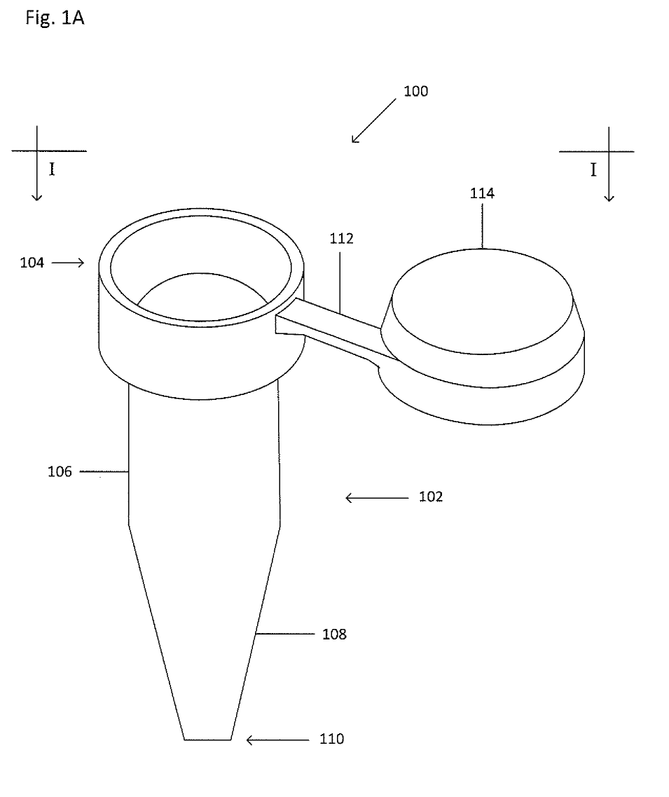

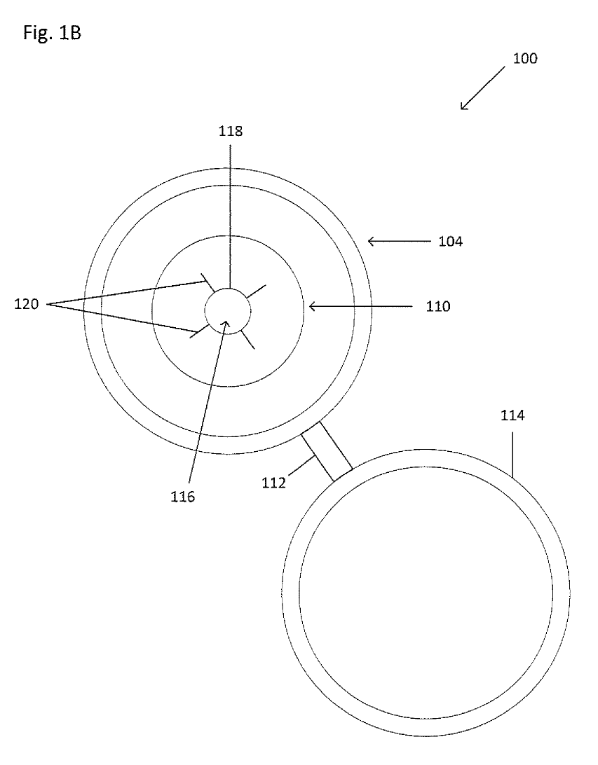

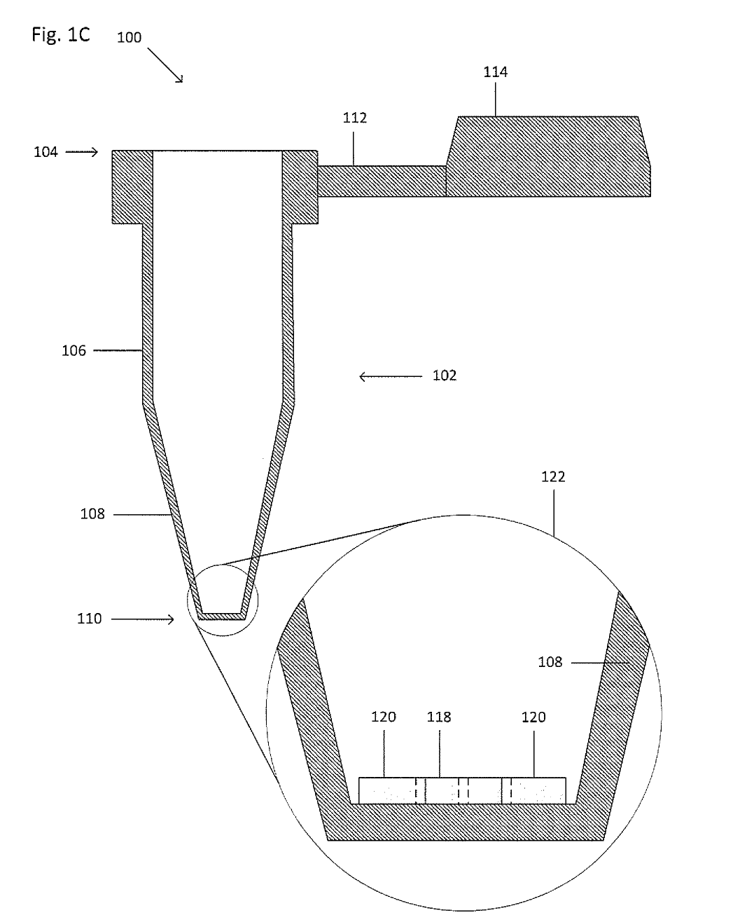

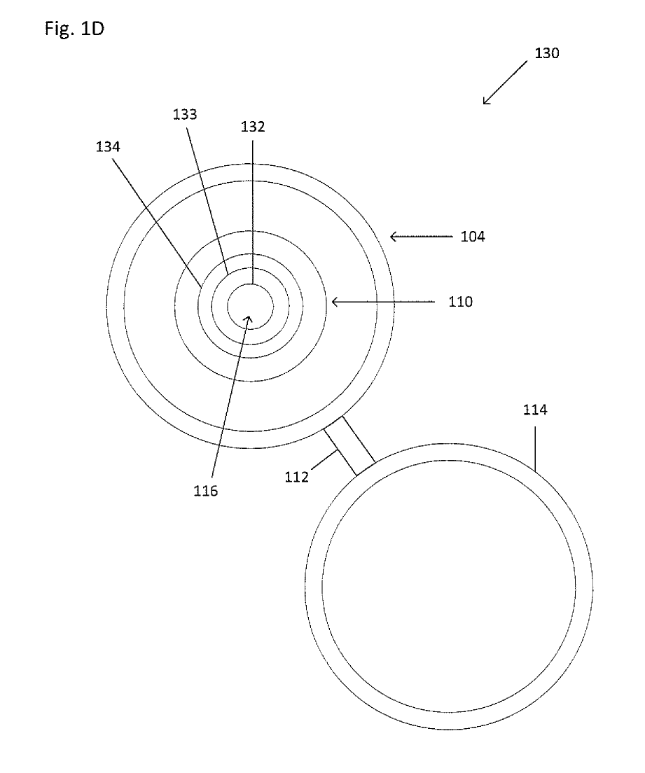

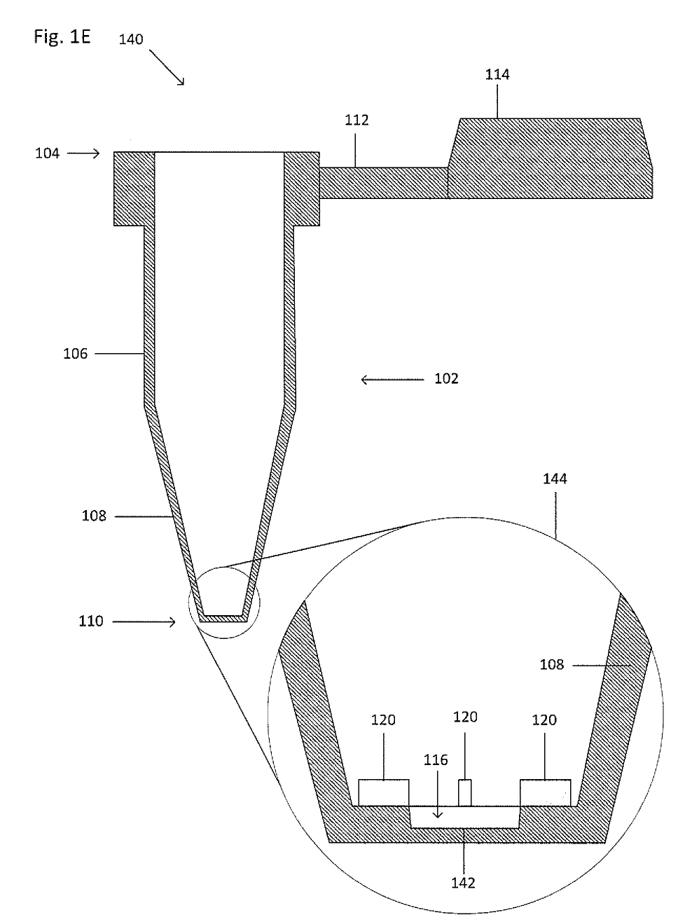

FIG. 1A shows an isometric view of a tube 100. The tube 100 includes a main body 102 which is a hollow tube having a first flat end 110 and a second end 104 opposite that of the flat end 110. The main body 102 includes an upper cylindrical section 106 which is connected to a lower frustoconical section 108 with the lower frustoconical section 108 ending in the first flat end 110. The transition from the frustoconical section 108 to the flat end 110 may include a curve or may be angular (i.e. not curved; two adjoining walls with an abrupt and discrete transition). The second end 104 is configured to receive a cap 114 and a sample or fluid. The cap 114 seals the second end 104. The cap 114 may be connected to the main body 102 via a connector 112. The cap 114 may include at least one rib (not shown) running vertically or circumferentially around the portion of the cap 114 to be inserted into the main body 102. The at least one rib (not shown) permits for an interference fit to provide a more secure fit between the cap 114 and the main body 102. To permit bending or folding for insertion of the cap 114 into the second end 104, the connector 112 may be flexible or the connector 112 may include a single hinge, a double hinge, or any number of appropriate hinges. Alternatively, the cap 114 may be a separate piece from the main body 102, thereby not being connected to the main body 102 by the connector 112. Alternatively, the cap 114 may be connected to a collar (not shown) which includes a ring with the connector 112 extending from the ring to the cap 114. An internal diameter of the ring may be sized and shaped to accept at least a portion of the main body 102.

The flat end 110 allows for visualization, such as by imaging, of the contents of the tube 100 before, during, and/or after the reaction process. Imaging the contents permits the operator to confirm the presence of the sample within the tube 100 prior to the start of the reaction process. For example, the sample, such as a cell, may not discernible by eye and may therefore not actually be added to the tube 100. Though the addition of a droplet suspected of including the sample can be determined by eye, the droplet may not include the desired sample. The flat end 110 allows for imaging during the reaction process. This imaging may be done concurrently with the reaction process or may be step-wise, whereby the contents are imaged at discrete points or steps along the reaction process to confirm the effects of the reaction process. For example, a reagent may be added to the tube to lyse the sample. Imaging allows the operator to confirm lysis of the sample. Imaging may also be done after completion of the reaction. Imaging after the reaction is complete may be done to confirm that a successful reaction has occurred and/or to determine emission levels from labeling molecules. Examples of suitable labeling molecules include, but are not limited to, fluorescent molecules including, but not limited to, quantum dots; commercially available dyes, such as fluorescein, Hoechst, Cyber Green, FITC (“fluorescein isothiocyanate”), R-phycoerythrin (“PE”), Texas Red, allophycocyanin, Cy5, Cy7, cascade blue, DAPI (“4′,6-diamidino-2-phenylindole”) and TRITC (“tetramethylrhodamine isothiocyanate”); combinations of dyes, such as CY5PE, CY7APC, and CY7PE; reaction-confirmation probes; metal-conjugated antibodies; and synthesized molecules, such as self-assembling nucleic acid structures (e.g. DNA barcodes). The labeling molecules may be bound to a ligand to bind with a surface marker, intracellular marker, or nucleic acid marker to provide an emission light for proper imaging. Many solutions may be used, such that each solution includes a different type of labeling molecule bound to a different ligand.

FIG. 1B shows a top down view of the tube 100. FIG. 1C shows a cross-section view of the tube 100 taken along the line I-I. The flat end 110 includes a microwell 116 to hold at least a portion of the sample added to the tube 100. The microwell 116 may be formed by a partition 118 extending from the flat end 110 to the second end 104, as seen in magnified view 122. The flat end 110 may include at least one spoke 120 extending from the partition 118 towards the frustoconical section 108 of the tube 100 and extending from the flat end 110 to the second end 104. The at least one spoke 120 may be a fiducial to aid in determining proper focusing of the flat end 110 and proper sample placement. The proper focal point may also be determined based on the partition 118. The microwell 116 may have a volume range of approximately 10 nanoliters to approximately 10 microliters. The diameter of the microwell 116 may range from approximately 20 μm to approximately 50 μm. The height of the partition 118 may range from approximately 50 μm to approximately 450 μm. The height of the at least one spoke 120 may range from approximately 0 μm (i.e. not raised off of the flat end 110) to approximately 450 μm.

FIG. 1D shows top down view of a tube 130 which is similar to the tube 100 except that the microwell 116 may be formed by an inner partition 132 and surrounded by concentric partitions 133-134, such that no two partitions have the same diameter and/or height to hold different sample amounts and/or to provide different focusing levels. The concentric partitions 133-134 may form microtroughs which have a volume range of approximately 11 nanoliters to approximately 11 microliters which includes the volume of the microwell 116. The diameter of the microwell 116 may range from approximately 20 μm to approximately 50 μm. The diameter of the concentric partitions 133-134 may range from approximately 21 μm to approximately 500 μm. The height of the partitions 132-134 may range from approximately 50 μm to approximately 450 μm. The inner partition 132 may be the shortest, medium, or tallest of the partitions 132-134. The total number of partitions may be equal to or greater than 2 (i.e the inner partition 132 and at least one concentric partition).

FIG. 1E shows a tube 140 which is similar to the tube 100 except that the microwell 116 may be formed by a cavity 142 within the flat end 110, as seen in magnified view 144. The cavity 142 may have a depth range from approximately 1 μm below an inner wall of the flat end 110 to approximately 1 μm above an outer wall of the flat end 110. The flat end 110 may include at least one spoke 120 extending from an edge of the microwell 116 towards the frustoconical section 108 of the tube 100 and extending from the flat end 110 to the second end 104. The at least one spoke 120 may be a fiducial to aid in determining a proper focal point of the flat end 110. The diameter of the microwell 116 may range from approximately 20 μm to approximately 50 μm. The height of the at least one spoke 120 may range from approximately 0 μm (i.e. not raised off of the flat end 110) to approximately 450 μm.

The flat end 110 may carry a net charge that is opposite a net charge of the sample being added to the tube 100. For example, when the net charge of the sample being added is negative, the flat end 110 carries a net positive charge. The opposite charge causes the sample to be drawn to the flat end 110 so that the sample does not adhere or stick to the upper cylindrical section 106 or the lower frustoconical section 108. The flat end 110 may be composed of a material that naturally has a particular charge or that may be induced to carrying a particular charge. Alternatively, the flat end 110 may include a coating that has a particular charge. Alternatively, the flat end 110 may be functionalized, thereby inducing a net change on the flat end 110. Drawing the sample to the flat end 110 allows for better imaging rather than the sample being stuck on the upper cylindrical section 106 or the lower frustoconical section 108. In one implementation, neither the upper cylindrical section 106 nor the lower frustoconical section 108 carries a net charge (i.e. the upper cylindrical section 106 and the lower frustoconical section 108 are neutral or carry no charge). The cap 114 may either be neutral (i.e. carries no charge) or may have the same net charge as the sample. To inhibit the build-up or carrying of a net electrostatic charge, the cap 114, the upper cylindrical section 106 and the lower frustoconical section 108 may be grounded. Alternatively, the cap 114, the upper cylindrical section 106 and the lower frustoconical section 108 may include a coating to inhibit the build-up or carrying of a net electrostatic charge. The flat end 110, having the net opposite charge from the sample, attracts the sample, while the upper cylindrical section 106 and the lower frustoconical section 108 neither adhere nor attract the sample. In yet another implementation, the upper cylindrical section 106 and the lower frustoconical section 108 carry the same net charge as the net charge of the sample added to the tube. The flat end 110, having the net opposite charge from the sample, attracts the sample, while the upper cylindrical section 106 and the lower frustoconical section 108, both of which the same net charge as the sample, repel the sample towards the flat end 110. The cap 114 may either be neutral (i.e. carries no charge) or may have the same net charge as the sample. The coatings, for example, may include, but are not limited to, bovine serum albumine or Sigma coat.

The cap 114 may be composed of re-sealable rubber or other suitable re-sealable material that can be repeatedly punctured with a needle or other sharp implement to access the contents of the tube 100 interior and re-seals when the needle or implement is removed.

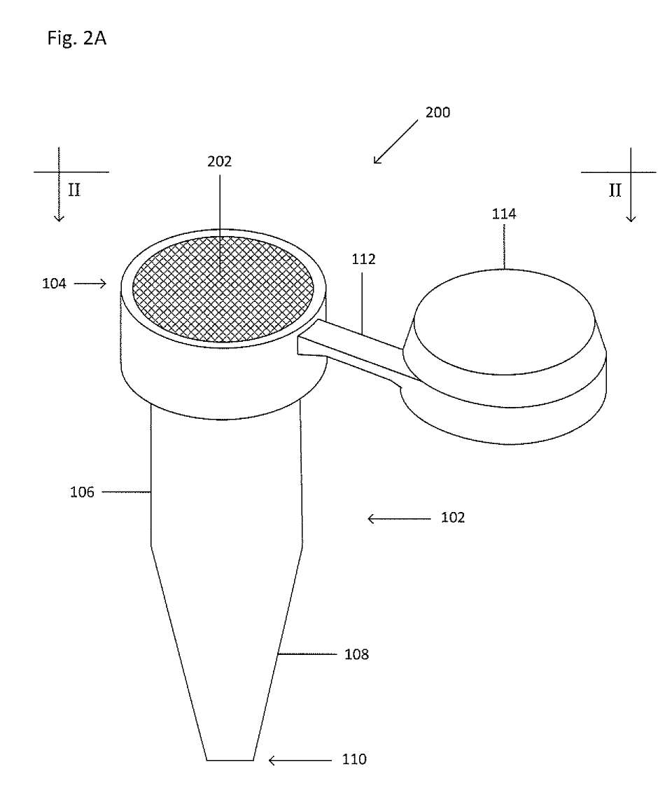

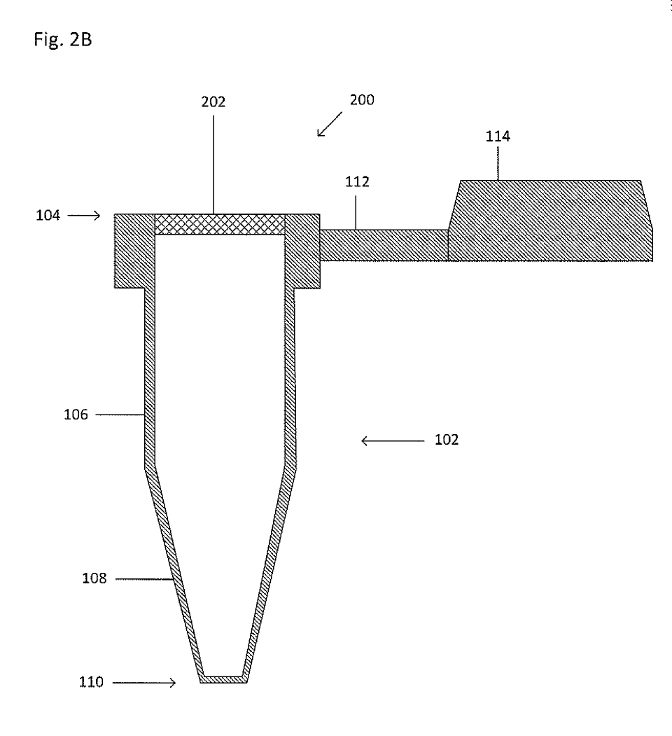

FIG. 2A shows an isometric view of a tube 200. FIG. 2B shows a cross-section view of the tube 200 taken along the line II-II. The tube 200 is similar to the tube 100 except that the tube 200 includes a puncturable membrane 202 at the second end 104. The puncturable membrane 202 prevents contamination of the tube 200. The puncturable membrane 202 maintains a seal at the second end 104 without requiring the cap 114 to be closed, which would prevent access to the tube 200. Once the puncturable membrane 202 has been punctured, the puncturable membrane 202 may be peeled back to permit the cap 114 to be inserted into the open 104 or the cap 114 may puncture and be inserted through the puncturable membrane 202. For example, the puncturable membrane 202 may be a piece of aluminum adhered to the second end 104. A pipette tip, a needle, or any other appropriate device carrying the sample may puncture the aluminum and expel the contents into the main body 102 of the tube 200.

The puncturable membrane 202 can be composed of re-sealable rubber or other suitable re-sealable material that can be repeatedly punctured with a needle or other sharp implement to access the contents of the tube 200 interior and re-seals when the needle or implement is removed. The puncturable membrane 202 can be composed of metals, organic or inorganic materials, or plastic materials, such as polymeric materials. The puncturable membrane 202 may be a valve which flexes inward when pushed by the cap 114, a pipette or appropriate device for introducing the sample into the tube 200. The valve may include a single slit, a cross slit, or a Y slit.

The tube is composed of a heat conducting material. The tube can be composed of a transparent, semitransparent, opaque, or translucent material. The flat end may be composed of a different material than the rest of the tube, though the flat end is still optically clear. The flat end enhances imaging by reducing or eliminating reflections and refractions from excitation and emission lights while improving the sensitivity and specificity of an imaging system.

The tube can be composed of glass; organic or inorganic materials, plastic materials, and polymeric materials, including, but not limited to, cyclic polyolefins and polyolefins (e.g., polyethylene, polypropylene); and combinations thereof. The cap can be composed of organic or inorganic materials, plastic materials, silicon or silicone materials, and polymeric materials, including, but not limited to, cyclic polyolefins and polyolefins (e.g., polyethylene, polypropylene); and combinations thereof. For example, the flat end may be composed of glass and the rest of the main body and the cap may be composed of cyclic polyolefin.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

I/we claim:

1. A tube comprising:
a hollow main body including a first flat end and a second end opposite that of the flat end,
wherein the flat end includes a microwell to hold at least a portion of a sample added to the tube.

2. The tube of claim 1, wherein the flat bottom is optically clear.

3. The tube of claim 1, wherein the microwell is formed by a partition extending from the flat end towards the second end.

4. The tube of claim 3, wherein the height of the partition ranges from approximately 50 μm to approximately 450 μm.

5. The tube of claim 4, wherein the diameter of the microwell ranges from approximately 20 μm to approximately 50 μm.

6. The tube of claim 3, further comprising at least one spoke extending from the partition towards a frustoconical section of the hollow main body.

7. The tube of claim 6, wherein the height of the at least one spoke ranges from approximately 0 μm to approximately 450 μm.

8. The tube of claim 1, further comprising at least one concentric partition surrounding the microwell, wherein the microwell is formed by an inner partition extending from the flat end towards the second end.

9. The tube of claim 8, wherein no two partitions have the same diameter or height.

10. The tube of claim 9, wherein the diameter of the microwell ranges from approximately 20 μm to approximately 50 μm, wherein the diameter of the at least one concentric partition ranges from approximately 21 μm to approximately 500 μm, and wherein the height of any partition ranges from approximately 50 μm to approximately 450 μm.

11. The tube of claim 1, wherein the microwell is formed by a cavity within the flat end.

12. The tube of claim 11, wherein the diameter of the microwell ranges from approximately 20 μm to approximately 50 μm.

13. The tube of claim 12, wherein the cavity has a depth range from approximately 1 μm below an inner wall of the flat end 110 to approximately 1 μm above an outer wall of the flat end 110.

14. The tube of claim 11, further comprising at least one spoke extending from an edge of the microwell towards a frustoconical section of the hollow main body.

15. The tube of claim 14, wherein the height of the at least one spoke ranges from approximately 0 μm to approximately 450 μm.

16. The tube of claim 1, further comprising a puncturable membrane at the second end, such that the puncturable membrane re-seals after being punctured.

17. The tube of claim 1, wherein the microwell have a volume ranging from approximately 10 nanoliters to approximately 10 microliters.

18. The tube of claim 1, further comprising a cap to seal the second end.

19. The tube of claim 18, wherein the cap is re-sealable, such that the cap re-seals after being punctured.

20. The tube of claim 1, wherein the hollow main body further comprises:
an upper cylindrical section,
a lower frustoconical section,
wherein the flat end is at the end of the lower frustoconical section, and
wherein the second end is opposite that of the flat end.
